(19) United States
(12) Patent Application Publication
(10) Pub. No.: US 2007/0095627 A1
(43) Pub. Date: May 3, 2007

(54) Externally-controlled fluid coupling

(75) Inventors: Mitsutoshi Hagiwara, Anjo-shi (JP); Hironori Yoshida, Toyota-shi (JP); Hideyuki Suzuki, Toyohashi-shi (JP); Ryosuke Mori, Chiryu-shi (JP)

Correspondence Address: REED SMITH LLP;Suite 1400, 3110 Fairview Park Drive, Falls Church, VA, 22042, US

(73) Assignee: Aisin Seiki Kabushiki Kaisha

(21) Appl. No.: 11/546,278

(22) Filed: Oct. 12, 2006

(30) Foreign Application Priority Data
Oct. 28, 2005 (JP) 2005-314527

(51) Int. Cl. F16D 31/00

(52) U.S. Cl. 192/58.61

(57) ABSTRACT

An externally-controlled fluid coupling includes a driving disk fixed to a driving rotational shaft, a case member and a cover member rotatably supported by the rotational shaft, a separating plate for forming an operation chamber and a storage chamber between the case member and the cover member, a supply passage for supplying the fluid to the operation chamber, a return passage for returning the fluid to the storage chamber, a supply/return valve for opening or closing the supply/return passage and an electromagnetic actuating apparatus including an electromagnet for actuating the supply/return valves. The electromagnet generates a first power of magnetism for actuating the supply valve and a second power of magnetism for actuating the return valve. The values of the first and second powers of magnetism are different from each other so that the supply valve and the return valve open/close nonsynchronously.

### CROSS REFERENCE TO RELATED APPLICATIONS

This application is based on and claims priority under 35 U.S.C. § 119 to Japanese Patent Application 2005-314527, filed on Oct. 28, 2005, the entire content of which is incorporated herein by reference.

### FIELD OF THE INVENTION

This invention generally relates to an externally-controlled fluid coupling. More specifically, this invention pertains to an externally-controlled fluid coupling for a cooling fan for a vehicle engine.

### BACKGROUND

As a conventional fluid coupling for a cooling fan, a fluid coupling, in which a valve provided in a communicating passage between an operation chamber and a storage chamber is operated by temperature change of a bimetal to control the amount of a fluid supplied to the operation chamber and in turn to control torque transmitted from a driving disk to a case, is known. JP2004-162911A discloses an externally-controlled fluid coupling including an electromagnet instead of a bimetal and an opening/closing valve, which opens/closes a hole of a supply passage, in which a fluid flows from a storage chamber to an operation chamber, by magnetic force exerted from the electromagnet to externally control the amount of the fluid flowing from the storage chamber to the operation chamber and in turn to control rotation of a fan. In the externally-controlled fluid coupling, because the opening/closing valve is provided only in the supply passage, in which the fluid flows from the storage chamber to the operation chamber, at the time when an engine stops, in other words, in a situation where a driving rotational member stops, the fluid stored in the storage chamber flows out to the operation chamber side through a return passage. As a result, there is a drawback that rotation of the fan may occur and cause noise at the next time of starting the engine.

A fluid coupling designed for overcoming the above drawback is disclosed in JPH04 (1992)-258529A. The fluid coupling includes two ring-shape electromagnets provided on the same shaft center. One of the electromagnets actuates a supply valve for opening/closing a supply passage, in which a fluid flows from a storage chamber to an operation chamber. The other one of the electromagnets actuates a return valve for opening/closing a return passage, in which the fluid flows from the operation chamber to the storage chamber. The externally-controlled fluid coupling has an advantage that the supply valve and the return valve can be controlled to open/close nonsynchronously. However, because two ring-shape electromagnets provided on the same shaft center are utilized, a diameter of an outer electromagnet becomes large, which increases weight thereof. Further, because an area of the outer electromagnet, through which magnetic flux passes, becomes large, a magnetic material (pulled member) provided at the side of the valve also need to be large for obtaining necessary pulling force. As a result, the valve itself becomes large, which tends to cause high cost and lowering reliability.

A need thus exists for a simply configured externally-controlled fluid coupling, which can control a flow rate of a fluid flowing in a supply passage and a return passage nonsynchronously. The present invention has been made in view of the above circumstances and provides such an externally-controlled fluid coupling.

### SUMMARY OF THE INVENTION

According to an aspect of the present invention, an externally-controlled fluid coupling includes a driving disk fixed to a driving rotational shaft, a case member rotatably supported by the driving rotational shaft, a cover member hermetically connected to the case member to form an inner space between the case member and the cover member, a separating plate for separating the inner space into an operation chamber accommodating the driving disk and a storage chamber for storing a fluid, a supply passage for supplying the fluid from the storage chamber to the operation chamber, a return passage for returning the fluid from the operation chamber to the storage chamber, a supply valve for opening/closing the supply passage, a return valve for opening/closing the return passage and an electromagnetic actuating means for actuating the supply valve and the return valve to open/close on the basis of a control signal from a controller. The electromagnetic actuating means includes an electromagnet commonly utilized for actuating the supply valve and the return valve. The electromagnet generates a first power of magnetism for opening or closing the supply valve and a second power of magnetism for opening or closing the return valve. The values of the first and second powers of magnetism are different from each other so that the supply valve and the return valve open/close nonsynchronously.

### BRIEF DESCRIPTION OF THE DRAWINGS

The foregoing and additional features and characteristics of the present invention will become more apparent from the following detailed description considered with reference to the accompanying drawings, wherein:

FIG. 1 represents a cross-sectional view illustrating an externally-controlled fluid coupling according to an embodiment of the present invention;

FIG. 2 represents a front view illustrating the externally-controlled fluid coupling illustrated in FIG. 1;

FIG. 3 represents a detail view illustrating a supply passage;

FIG. 4 represents a detail view illustrating a return passage;

FIG. 5 represents a detail view illustrating an electromagnetic actuating means;

FIGS. 6A, 6B and 6C represent explanatory diagrams typically illustrating valve configurations, of which biasing force of springs are different;

FIGS. 7A, 7B and 7C represent explanatory diagrams typically illustrating different valve control modes;

FIGS. 8A, 8B and 8C represent explanatory diagrams typically illustrating valve configurations of different areas, at which magnetic force is exerted;

FIGS. 9A and 9B represent explanatory diagrams typically illustrating supply passages, of which diameters of exits are different; and

FIGS. 10A and 10B represent explanatory diagrams typically illustrating supply passages, of which the number of exits to the operation chamber is different.

### DETAILED DESCRIPTION

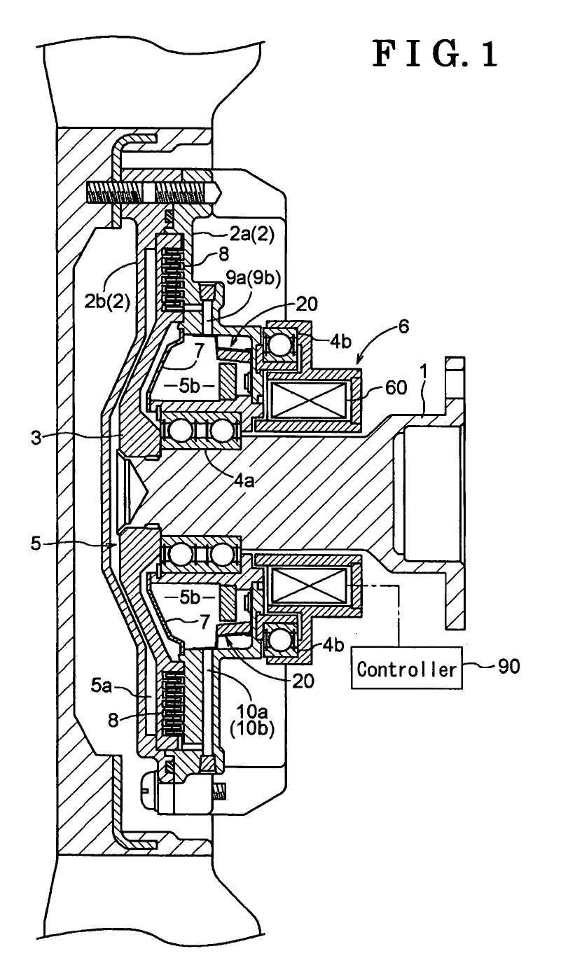

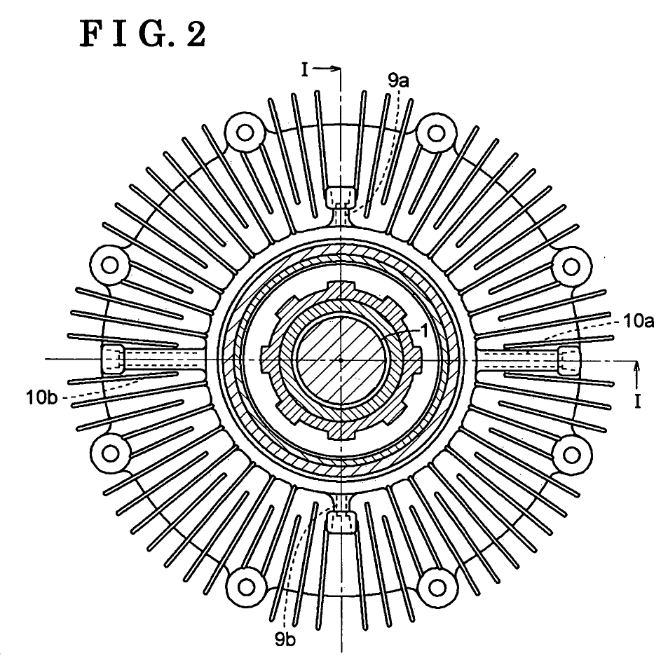

An embodiment of the present invention will be explained with reference to drawing figures. FIG. 1 represents a cross-sectional view illustrating an externally-controlled fluid coupling according to the embodiment of the present invention. FIG. 2 represents a schematic front view illustrating the same, in which a rotational shaft, or the like, is partially omitted. FIG. 1 is a cross-sectional view taken on line of I-I of FIG. 2.

The fluid coupling includes a driving rotational shaft 1, to which driving force is transmitted from an engine (not illustrated), and a housing 2 as a driven rotational member. A cooling fan for the engine is attached to a peripheral portion of the housing 2. A driving disk 3 is fixed to an end portion of the driving rotational shaft 1. The housing 2 is configured from a ring-plate-shape case member 2a supported by the driving rotational shaft 1 through a first bearing 4a and rotatable about the driving rotational shaft 1 and a cover member 2b hermetically connected to the peripheral portion of the case member 2a by a screw and a seal for forming an inner space 5 accommodating the driving disk 3 between the cover member 2b and the case member 2a. In the inner space 5, for example, viscous fluid such as silicon oil, or the like, is stored. A ring-shaped electromagnetic actuating means 6, which will be detailed later, is provided between the driving rotational shaft 1 and the case member 2a.

The inner space 5 is divided by a ring-shape separating plate 7 in a direction perpendicular to the rotational driving shaft 1 into two sections, namely an operation chamber 5a accommodating the driving disk 3 and a storage chamber 5b for storing a fluid. Configuration members of the electromagnetic actuating means 6 are provided in the storage chamber 5b. A labyrinth portion 8, which functions as a torque transmitting portion, is formed in the operation chamber 5a at a position where the driving disk 3 and the case member 2a face each other.

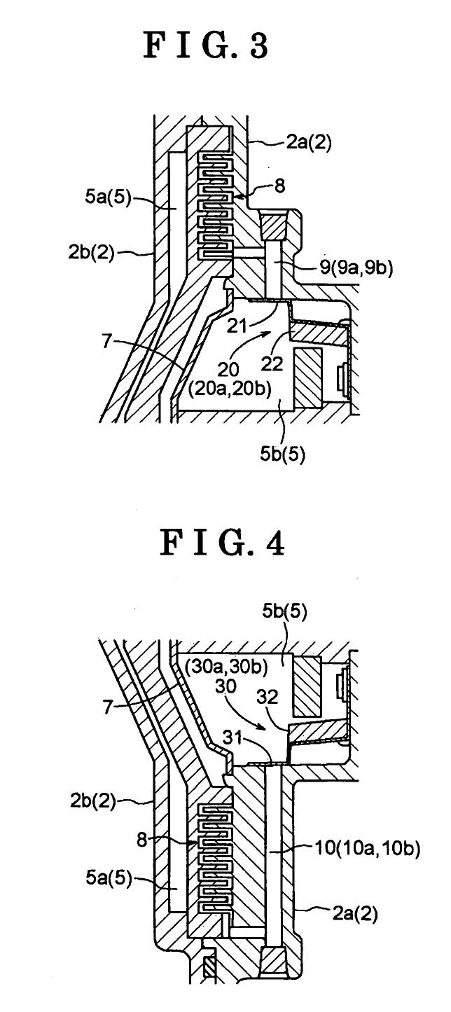

As detailed in FIG. 3, a communicating hole is formed at the case member 2a from a position facing the storage chamber 5b of the case member 2a to a position facing the operation chamber 5a in an area of the labyrinth portion 8. The communicating hole serves as a supply passage 9 for supplying the fluid from the storage chamber 5b to the operation chamber 5a. In the embodiment of the present invention, two supply passages 9, in other words, a first supply passage 9a and a second supply passage 9b, are provided so that the second supply passage 9b is located at a position shifted from that of the first supply passage 9a by an angle of 180° in a peripheral direction, in other words, so that the first supply passage 9a and the second supply passage 9b are axially symmetric.

As detailed in FIG. 4, a communicating hole is formed at the case member 2a from a position facing the operation chamber 5a in an area outside the labyrinth portion 8 of the case member 2a to a position facing the storage chamber 5b. The communicating hole serves as a return passage 10 for returning the fluid from the operation chamber 5a to the storage chamber 5b. In the embodiment of the present invention, two return passages 10, in other words, a first return passage 10a and a second return passage 10b, are provided so that the second return passage 10b is located at a position shifted from that of the first return passage 10a by an angle of 180° in a peripheral direction, in other words, the first return passage 10a and the second return passage 10b are axially symmetric. In the meantime, the first return passage 10a and the second return passage 10b are provided at an intermediate position between the first supply passage 9a and the second supply passage 9b in a peripheral direction respectively.

As further detailed in FIG. 3, a supply valve 20 configured from a belt-shape spring member 21 is provided at an opening of the supply passage 9 at the side of the storage chamber 5b. An end portion of the spring member 21 is formed as a sealing surface for closing the opening of the supply passage 9 by biasing force of the spring member 21. A base end portion of the spring member 21 is fixed to the case member 2a. The spring member 21 is cantilevered, and biasing force according to curving of the spring member 21 functions to close the opening of the supply passage 9. A pulled portion 22 made of magnetic material is provided at a middle portion of the spring member 21. In a situation where magnetic force generated by the electromagnetic actuating means 6 is exerted to the pulled portion 22, the spring member 21 is moved against the biasing force, and the supply valve 20 is opened from a closed state. Here, the supply valve 20 is provided at each of the first supply passage 9a and the second supply passage 9b. A supply valve 20 provided at the first supply passage 9a will be referred to as a first supply valve 20a and a supply valve 20 provided at the second supply passage 9b will be referred to as a second supply valve 20b, as necessity arises. As further detailed in FIG. 4, a return valve 30 is provided at an opening of the return passage 10. A configuration of the return valve 30 is similar to that of the supply valve 20. The return valve 30 includes a spring member 31 and a pulled portion 32. The return valve 30 is provided at each of the first return passage 10a and the second return passage 10b. A return valve 30 provided at the first return passage 10a will be referred to as a first return valve 30a and a return valve 30 provided at the second return passage 10b will be referred to as a second return valve 30b, as necessity arises.

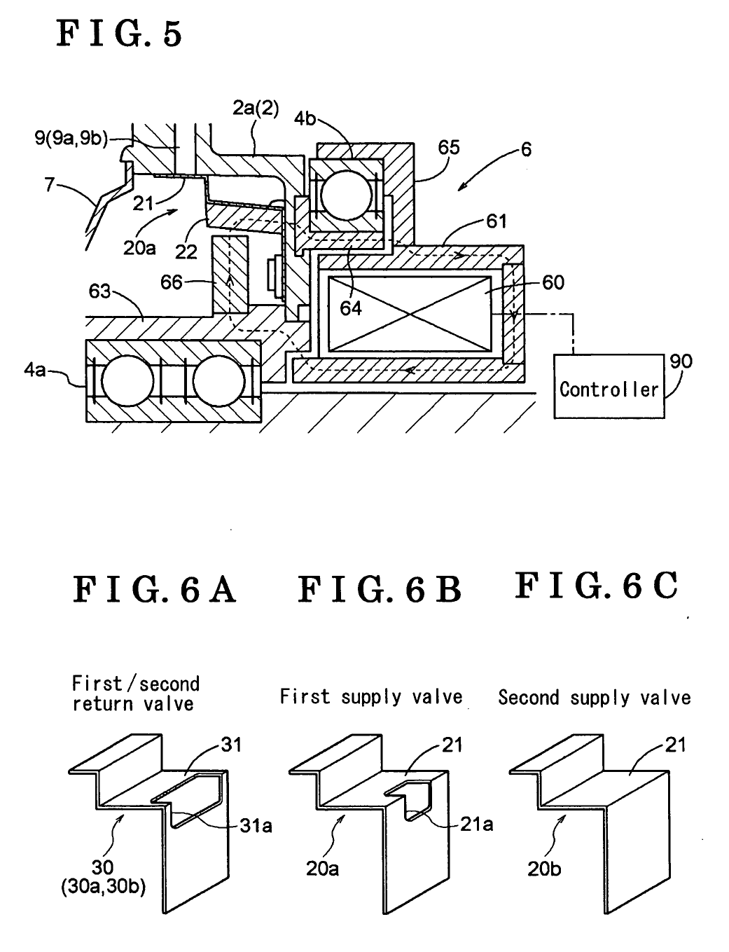

For opening the supply valve 20 and the return valve 30 closed by biasing force of respective spring members 21 and 31 against the biasing force, the electromagnetic actuating means 6 exerts magnetic force to the pulled portions 22 and 32 of the supply valve 20 and the return valve 30. A configuration of the electromagnetic actuating means 6 will be explained with reference to FIG. 5. The configuration of the electromagnetic actuating means 6 is substantially common to all of the supply valves 20 and the return valves 30. Accordingly, explanation will be made taking an example from the first supply valve 20a.

As can be grasped with reference to FIGS. 1, 2 and 5, the electromagnetic actuating means 6 includes one ring-shape electromagnet 60 provided coaxially with the driving rotational shaft 1, a circular yoke 61 having a ring groove for accommodating the electromagnet 60, a first ring 63 fitted to outside of an outer race of the first bearing 4a and attached to the case member 2a, a second ring 64 provided outside the first ring 63 and attached to the case member 2a so that the second ring 64 is magnetically connected with the pulled portion 22 of the first supply valve 20a, a bracket ring 65 assembled with the second ring 64 through the second bearing 4b and connected to the circular yoke 61 and a valve-pulling portion 66 fixed to an outer peripheral surface of the first ring 63 so that the valve-pulling portion 66 faces the pulled portion 22 of the first supply valve 20a. The circular yoke 61, the first ring 63, the second ring 64, the bracket ring 65 and the valve-pulling portion 66 are made of magnetic material. As a result, a closed magnetic circuit, in which the electromagnet 60 is a source of magnetism, is configured from the circular yoke 61, the first ring 63, the second ring 64, the pulled portion 22 and the bracket ring 65. In a situation where electricity is applied to the electromagnet 60 on the basis of a control signal of a controller 90, the pulled portion 22 is pulled toward the valve-pulling portion 66. Then, the first supply valve 20a is opened. In the meantime, the first supply valve 20a, the second supply valve 20b, the first return valve 30a and the second return valve 30b are positioned on a circumference, which is coaxial with a center of the ring-shape electromagnet 60 and of which a diameter is the same as a diameter of a central circumference of the ring-shape electromagnet 60, to face the electromagnet 60 so that the first supply valve 20a, the second supply valve 20b, the first return valve 30a and the second return valve 30b can be actuated to open/close by one common electromagnet 60.

As typically illustrated in FIGS. 6A, 6B and 6C, in the embodiment of the present invention, an outer shape of the spring member 21 of the first supply valve 20a is the same as that of the spring member 21 of the second supply valve 20b. The spring member 21 of the first supply valve 20a has a hole 21a at a middle portion thereof. On the other hand, the spring member 21 of the second supply valve 20b does not have such a hole 21 a at a middle portion (vicinity of a bended portion) thereof. Accordingly, biasing force for closing the first supply valve 20a is smaller than that for closing the second supply valve 20b. As a result, pulling force required for opening the first supply valve 20a is smaller than that required for opening the second supply valve 20b. The spring member 31 of the first return valve 30a is the same as that of the second return valve 30b. Outlines of the spring members 31 of the first return valve 30a and the second return valve 30b are the same as that of the spring member 21 of the supply valve 20. However, each of the spring members 31 of the first return valve 30a and the second return valve 30b has a hole 3 1a larger than the hole 21 a of the first supply valve 20a at a middle portion (vicinity of a bended portion) thereof. Accordingly, biasing force for closing the return valve 30 is smaller than that for closing the first supply valve 20a and the second supply valve 20b. As a result, pulling force required for opening the return valve 30 is smaller than that required for opening the first supply valve 20a and the second supply valve 20b.

As described above, pulling force required for opening the second supply valve 20b, the first supply valve 20a and the return valve 30 becomes smaller stepwise. Such a configuration of the spring members enables various valve control modes for the controller 90, which controls current inputted to the electromagnet 60 to control the supply valve 20 and the return valve 30. The control modes will be explained.

In a situation where current inputted to the electromagnet 60 is zero current (approximate current value, at which spring members are not moved), the first supply valve 20a, all of the second supply valve 20b and the return valve 30 are maintained to close. Such a valve state of the fluid coupling will be referred to as a first state. In a situation where current inputted to the electromagnet 60 is a predetermined small current value (current value, at which power of magnetism for generating magnetic force for moving only the spring member 31 of the return valve 30 to open is generated), only the return valve 30 is opened, and the first supply valve 20a and the second supply valve 20b are maintained to close. Such a valve state of the fluid coupling will be referred to as a second state. In a situation where current inputted to the electromagnet 60 is a predetermined medium current value (current value, at which power of magnetism for generating pulling forces for moving only the spring member 31 of the return valve 30 and the spring member 21a of the first supply valve 20a to open is generated), the return valve 30 and the first supply valve 20a are opened, and only the second supply valve 20b is maintained to close. Such a valve state of the fluid coupling will be referred to as a third state. In a situation where current inputted to the electromagnet 60 is a predetermined large current value (current value, at which power of magnetism for generating pulling forces for moving all of the spring member 31 of the return valve 30, the spring member 21a of the first supply valve 20a and the spring member 21b of the second supply valve 20b to open is generated), all of the return valve 30, the first supply valve 20a and the second supply valve 20b are opened. Such a valve state of the fluid coupling will be referred to as a fourth state.

Operations of the externally-controlled fluid coupling configured as described above will be explained. In a state where an engine starts and the driving rotational shaft 1 is rotating, in a situation where a large current described above is applied to the electromagnet 60 on the basis of the control signal of the controller 90, the valve state becomes the fourth state. The first and second supply valves 20a and 20b and the first and second return valves 30a and 30b are opened. As a result, the fluid flows to the operation chamber 5a (labyrinth portion 8) from the storage chamber 5b through the first supply passage 9a and the second supply passage 9b. The fluid having flown into the operation chamber Sa flows through the labyrinth portion 8 and flows back to the storage chamber 5b through the first return passage 10a and the second return passage 10b with a help from a function of a pump mechanism (an obstacle for the fluid generally called a dam, made of elastic material, or the like) provided at a most outer peripheral portion of the inner space 5. Such a circulation of the fluid functions to transmit rotation of the driving disk 3, which is rotating integrally with the driving rotational shaft 1, to the housing 2 to rotate the housing 2, and as a result to rotate the fan, which cools a radiator and the engine. Further, in a situation where temperature lowering of radiator fluid, or the like, is detected by a sensor (not illustrated), the controller 90 emits a corresponding control signal to apply the middle current described above to the electromagnet 60. In this situation, the valve state becomes the third state. The first supply valve 20a and the first and second return valves 30a and 30b are maintained to open, and the second supply valve 20b is closed. As a result, the fluid flows to the operation chamber 5a from the storage chamber 5b through only the first supply passage 9a, and the amount of circulating fluid reduces. Accordingly, rotational frequency of the housing 2, in other words, the fan, reduces. At the time of stopping the engine, because electricity is not applied to the electromagnet 60, the valve state becomes the first state and the first and second supply valves 20a and 20b and the first and second return valves 30a and 30b are closed. In other words, because all of the return passages 10 are closed, back flow of the fluid from the storage chamber 5b to the operation chamber 5a can be inhibited. Accordingly, at the next time of starting the engine, transmission of rotation of the driving rotational shaft 1 to the housing 2, which leads to rotation of the fan, can be inhibited. In the meantime, in a situation where the valve state is the second state, the fluid can preferably be returned from the operation chamber 5a to the storage chamber 5b.

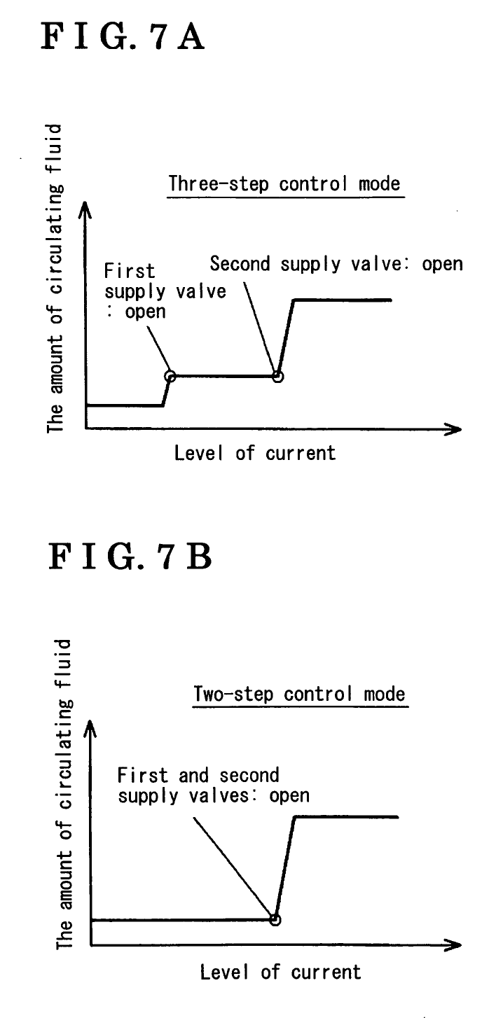

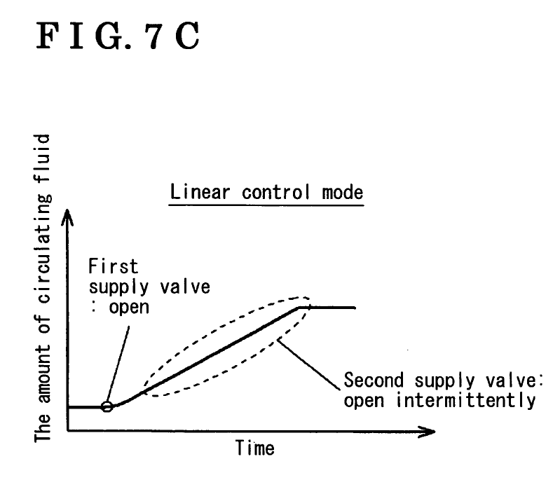

As described above, in this fluid coupling, different valve opened/closed states of, in particular, the first supply valve 20a and the second supply valve 20b, can be set by controlling current applied to the electromagnet 60 commonly utilized. Accordingly, the controller 90 can have different valve control modes. For example, as shown in a graph of FIGS. 7A, 7B and 7C, following modes can serve as examples.
a) Three-step (sequential) control mode: from a state where both of the first supply valve 20a and the second supply valve 20b are closed, at first only the first supply valve 20a is opened, and after that the second supply valve 20b is opened.
b) Two-step (simultaneous) control mode: from a state where both of the first supply valve 20a and the second supply valve 20b are closed, the first supply valve 20a and the second supply valve 20b are opened simultaneously.
c) Linear control mode (arbitrary acceleration of rotation): from a state where both of the first supply valve 20a and the second supply valve 20b are closed, at first only the first supply valve 20a is opened, and after that the second supply valve 20b is intermittently opened by pulse width modulation (PWM) control. Optimum selection from such various control modes enables proportional rise in rotational frequency of the fan for required airflow. In addition, optimum selection from such various control modes can vary a response time until the fan achieves necessary fan rotational frequency.

In the embodiment described above, variation of biasing force (spring constant) at the time when each valve moves to open produced valve states from the first state to the fourth state on the basis of one common electromagnet 60 as described above. Instead, in a second embodiment of the present invention, the same effect can be obtained from constant biasing force and different size of areas, at which magnetic force is exerted, between the valve-pulling portion 66 of the electromagnetic actuating means 6 and the pulled portions 22 and 32 of respective valves. In other words, the pulled portions 22 and 32 are configured so that, even in a situation where current applied to the electromagnet 60 is the same, magnetic force exerted to the pulled portions 22 and 32 from the valve-pulling portion 66 is different. Thus, the valve states from the first state to the fourth state are produced.

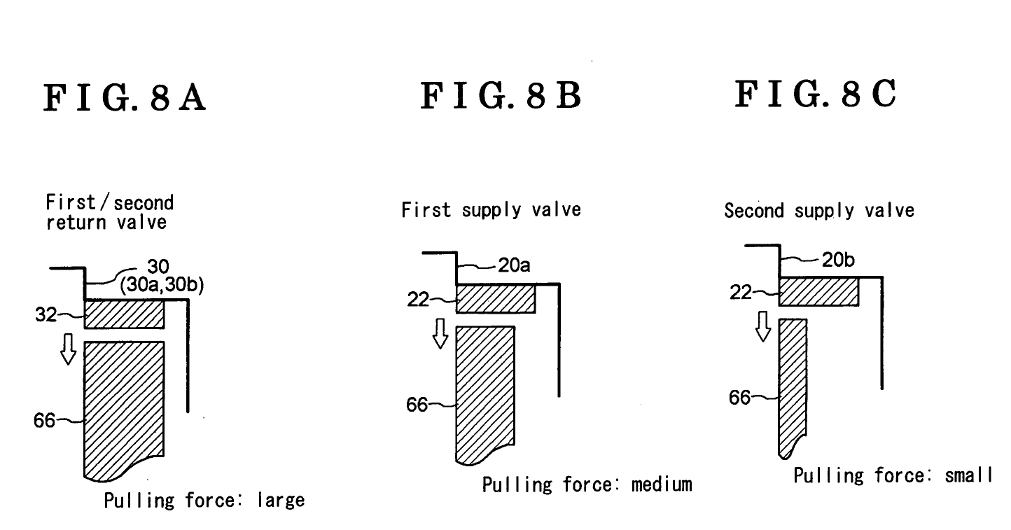

As an example thereof, as typically illustrated in FIGS. 8A, 8B and 8C, the valve-pulling portions 66, which face the pulled portions 32 of the first return valve 30a and the second return valve 30b respectively, is configured so that, the areas, at which magnetic force is exerted, are sufficiently large and the first return valve 30a and the second return valve 30b are opened in a situation where electricity, of which a level of current is the small current value described above, is applied to the electromagnet 60. Further, the valve-pulling portion 66, which faces the pulled portion 22 of the first supply valve 20a, is configured so that the area, at which magnetic force is exerted, is slightly smaller and the first supply valve 20a is opened in a situation where electricity, of which a level of current is the medium current value described above, is applied to the electromagnet 60. Further, the valve-pulling portion 66, which faces the pulled portion 22 of the second supply valve 20b, is configured so that the area, at which magnetic force is exerted, is still smaller and the second supply valve 20b is opened in a situation where electricity, of which a level of current is the large current value as described above, is applied to the electromagnet 60. By doing so, all of operations and effects of the valve control explained in the first embodiment can also be obtained in the fluid coupling according to the second embodiment.

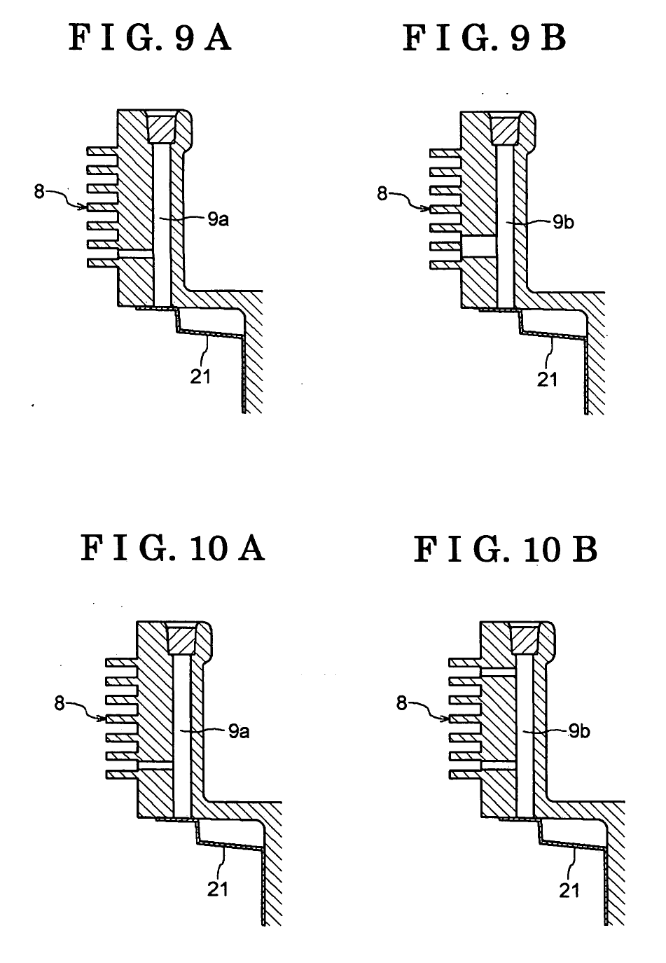

Variation examples of two embodiments described above will be explained.
1) In a first variation example, as typically illustrated in FIGS. 9A and 9B, a diameter of the exit of the first supply passage 9a is set to a value different from that of the second supply passage 9b. For example, the diameter of the exit of the second supply passage 9b (refer to FIG. 9B) is set to be larger than that of the first supply passage 9a (refer to FIG. 9A), thus creating different supply passage flow rates. By this, a wide difference can be produced in the amount of circulation of the fluid between a state (third state) where the fluid can flow only in the first supply passage 9a and a state (fourth state) where the fluid can flow in both of the first supply passage 9a and the second supply passage 9b. Accordingly, a wide difference in rotational frequency of the fan can be obtained.
2) In a second variation example, one exit to the operation chamber 5a is provided at the first supply passage 9a at an inner peripheral side of the labyrinth portion 8 (refer to FIG. 10A), and two exits to the operation chamber 5a are provided at the second supply passage 9b at inner and outer peripheral sides of the labyrinth portion 8 (refer to FIG. 10B). By doing so, in a situation where the fluid is permitted to flow in the second supply passage 9b in addition to the first supply passage 9a (fourth valve state), large torque transmitting function is generated in the labyrinth portion 8, which can heighten rotational speed of the fan, thus resulting in rapid cooling.

An externally-controlled fluid coupling according to the two embodiments and the variation examples of the present invention were explained. The embodiments and the variation examples can be applied solely or in arbitrary combinations. Further, examples of application of the externally-controlled fluid coupling technique are not limited only to the embodiments and variation examples described above. Configurational and functional variations can be made for various kinds of configuration elements, such as supply passages, return passages, supply valves and return valves provided thereat and an electromagnetic actuating means, within a frame of the invention.

According to a first aspect of the present invention, an externally-controlled fluid coupling includes a driving disk fixed to a driving rotational shaft, a case member rotatably supported by the driving rotational shaft, a cover member hermetically connected to the case member to form an inner space between the case member and the cover member, a separating plate for separating the inner space into an operation chamber accommodating the driving disk and a storage chamber for storing a fluid, a supply passage for supplying the fluid from the storage chamber to the operation chamber, a return passage for returning the fluid from the operation chamber to the storage chamber, a supply valve for opening/closing the supply passage, a return valve for opening/closing the return passage and an electromagnetic actuating means for actuating the supply valve and the return valve to open/close on the basis of a control signal from a controller. For independently controlling a flow rate of the fluid flowing in the supply passage and the return passage in a simple configuration, in the externally-controlled fluid coupling according to the aspect, the electromagnetic actuating means includes an electromagnet commonly utilized for actuating the supply valve and the return valve. The electromagnet generates a first power of magnetism for opening or closing the supply valve and a second power of magnetism for opening or closing the return valve. The values of the first and second powers of magnetism are different from each other so that the supply valve and the return valve open/close nonsynchronously (in arbitrary timings including simultaneous).

In this configuration, because power of magnetism generated by one common electromagnet causes to open/close the supply valve and the return valve, configuration of the electromagnetic actuating means can be simple. Further, because the electromagnet generates the first power of magnetism for opening or closing the supply valve and the second power of magnetism for opening or closing the return valve and the values of the first and second powers of magnetism are different from each other, the supply valve and the return valve can open/close nonsynchronously, such that generation of a first predetermined power of magnetism causes to open only the return valve and generation of a second predetermined power of magnetism causes to open not only the return valve but also the supply valve. By doing so, balances between the amount of the fluid returned from the operation chamber to the storage chamber and the amount of the fluid supplied from the storage chamber to the operation chamber can be varied. Accordingly, plural control results, such as multistage control of output rotational frequency, can be available.

For nonsynchronously opening/closing the supply valve and the return valve, according to a second aspect of the present invention, the supply valve includes a spring for exerting biasing force to close the supply valve, the return valve includes a spring for exerting biasing force to close the return valve, each of the supply valve and the return valve is opened in a situation where magnetic force exerted by the electromagnetic actuating means (electromagnet) is larger than the biasing force and the biasing force is differently set between the spring of the supply valve and that of the return valve. Biasing force can be easily changed by change of a spring constant determined from a cross-sectional shape, or the like. Accordingly, cost for manufacturing such a valve can be restricted to be low. For example, in a situation where a valve, which is opened from a closed state by weak magnetic force, and another valve, which is opened from a closed state by strong magnetic force, are prepared, selective generation of two strong/weak magnetic force correspondent thereto enables to sequentially open/close the supply valve and the return valve. Further, in a situation where there are plural supply valves and a return valve, or in a situation where there are a supply valve and plural return valves, or in a situation where there are plural supply valves and plural return valves, appropriate selection of a spring constant of each valve enables various output rotational frequency controls.

For opening/closing the supply valve and the return valve nonsynchronously, according to a third aspect of the present invention, the supply valve includes a spring for exerting biasing force to close the supply valve, the return valve includes a spring for exerting biasing force to close the return valve, each of the supply valve and the return valve is opened in a situation where magnetic force exerted by the electromagnetic actuating means (electromagnet) is larger than the biasing force and an area of the supply valve, the area at which magnetic force is exerted by the electromagnetic actuating means, is set to be different from an area of the return valve, the area at which magnetic force is exerted by the electromagnetic actuating means. In this configuration, biasing force of the springs are substantially the same between the valves. Instead, a size of the area, at which magnetic force is exerted, of the valves are varied so that magnetic force exerted to the valves, in other words, magnetic pulling force for operating the valves against the biasing force, becomes different even in a situation where power of magnetism generated by the electromagnetic actuating means is the same. For example, in a situation where a valve to which 100% of magnetic pulling force is exerted on the basis of a predetermined power of magnetism generated by the electromagnetic actuating means and a valve to which 50% of magnetic pulling force is exerted on the basis of the predetermined power of magnetism generated by the electromagnetic actuating means are prepared, appropriate generation of appropriately selected two different power of magnetism enables to open/close the valves sequentially. Here also, in a situation where plural supply valves and a return valve are provided, or in a situation where a supply valve and plural return valves are provided, or in a situation where plural supply valves and plural return valves are provided, appropriate selection of a size of the area, at which magnetic force is exerted, of each valve (in other words, selection of magnetic pulling force), enables to various output rotational frequency controls.

In a situation where the valve configuration described above, in which the supply valve and the return valve are opened/closed nonsynchronously with use of one common electromagnet, is employed, according to a fourth aspect of the present invention, the controller for giving a control signal to the electromagnetic actuating means includes a simultaneous mode to open/close the supply valve and the return valve simultaneously and a sequential mode to open/close the supply valve and the return valve sequentially. By doing so, stepwise control of output rotation or variable control of acceleration/deceleration can be easily available. At this time, according to a fifth aspect of the present invention, it is preferable that the power of magnetism generated by the electromagnetic actuating means is selected between maximum and minimum values in the simultaneous mode and the power of magnetism generated by the electromagnetic actuating means is selected stepwise in the sequential mode.

For realizing various output rotational frequency controls, according to a sixth aspect of the present invention, an externally-controlled fluid coupling includes a driving disk fixed to a driving rotational shaft, a case member rotatably supported by the driving rotational shaft, a cover member hermetically connected to the case member to form an inner space between the case member and the cover member, a separating plate for separating the inner space into an operation chamber accommodating the driving disk and a storage chamber for storing a fluid, plural supply passages for supplying the fluid from the storage chamber to the operation chamber, a return passage for returning the fluid from the operation chamber to the storage chamber, plural supply valves for opening/closing the supply passages respectively, a return valve for opening/closing the return passage, an electromagnetic actuating means for actuating the supply valves and the return valve on the basis of a control signal from a controller. An electromagnet generates a first power of magnetism for opening or closing one of the plurality of supply valves and a second power of magnetism for opening or closing another of the plurality of supply valves. The values of the first and second powers of magnetism are different from each other so that the plurality of supply valves open/close nonsynchronously (in arbitrary timings including simultaneous).

In this configuration, according to a seventh aspect, the plural supply passages are provided, plural supply valves are provided for opening/closing the supply passages respectively and the plural supply valves are opened/closed nonsynchronously. By doing so, the optimum amount of the fluid supplied from the storage chamber to the operation chamber can be set according to operational conditions.

For various control of the amount of the fluid supplied from the storage chamber to the operation chamber with use of supply passages nonsynchronously controlled by the respective supply valves, according to an eighth aspect of the present invention, one of the plural supply passages has an inner diameter different from that of another of the plural supply passages. Further, for supplying the fluid from the storage chamber to different suitable areas of the operation chamber, one of the plural supply passages includes plural exits to the operation chamber. By doing so, reliable output rotation control can be performed.

The principles, preferred embodiment and mode of operation of the present invention, have been described in the foregoing specification. However, the invention that is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. An externally-controlled fluid coupling, comprising:
a driving disk fixed to a driving rotational shaft;
a case member rotatably supported by the driving rotational shaft;
a cover member hermetically connected to the case member to form an inner space between the case member and the cover member;
a separating plate for separating the inner space into an operation chamber accommodating the driving disk and a storage chamber for storing a fluid;
a supply passage for supplying the fluid from the storage chamber to the operation chamber;
a return passage for returning the fluid from the operation chamber to the storage chamber;
a supply valve for opening/closing the supply passage;
a return valve for opening/closing the return passage;
an electromagnetic actuating means for actuating the supply valve and the return valve to open/close on the basis of a control signal from a controller;
the electromagnetic actuating means comprising an electromagnet commonly utilized for actuating the supply valve and the return valve; and
the electromagnet generating a first power of magnetism for opening or closing the supply valve and a second power of magnetism for opening or closing the return valve, the values of the first and second powers of magnetism are different from each other so that the supply valve and the return valve open/close nonsynchronously.

2. The externally-controlled fluid coupling according to claim 1, further comprising a second supply passage for supplying the fluid in the storage chamber to the operation chamber and a second supply valve for opening/closing the second supply passage, wherein
the supply valve and the second supply valve open/close nonsynchronously.

3. The externally-controlled fluid coupling according to claim 1, wherein
the supply valve includes a spring for exerting biasing force to close the supply valve,
the return valve includes a spring for exerting biasing force to close the return valve,
each of the supply valve and the return valve is opened in a situation where magnetic force exerted by the electromagnetic actuating means is larger than the biasing force and the biasing force is differently set between the spring of the supply valve and that of the return valve.

4. The externally-controlled fluid coupling according to claim 1, wherein
the supply valve includes a spring for exerting biasing force to close the supply valve,
the return valve includes a spring for exerting biasing force to close the return valve,
each of the supply valve and the return valve is opened in a situation where magnetic force exerted by the electromagnetic actuating means is larger than the biasing force and an area of the supply valve, the area at which magnetic force is exerted by the electromagnetic actuating means, is set to be different from an area of the return valve, the area at which magnetic force is exerted by the electromagnetic actuating means.

5. The externally-controlled fluid coupling according to claim 2, wherein
the second supply passage has an inner diameter different from that of the supply passage.

6. The externally-controlled fluid coupling according to claim 2, wherein
either one of the first supply passage and the second supply passage includes a plurality of exits to the operation chamber.

7. The externally-controlled fluid coupling according to claim 3, wherein
the controller includes a simultaneous mode to open/close the supply valve and the return valve simultaneously, the simultaneous mode in which a power of magnetism generated by the electromagnetic actuating means is selected between maximum and minimum values, and a sequential mode to open/close the supply valve and the return valve sequentially, the sequential mode in which a power of magnetism generated by the electromagnetic actuating means is selected stepwise.

8. An externally-controlled fluid coupling, comprising:
a driving disk fixed to a driving rotational shaft;
a case member rotatably supported by the driving rotational shaft;
a cover member hermetically connected to the case member to form an inner space between the case member and the cover member;
a separating plate for separating the inner space into an operation chamber accommodating the driving disk and a storage chamber for storing a fluid;
a plurality of supply passages for supplying the fluid from the storage chamber to the operation chamber;
a return passage for returning the fluid from the operation chamber to the storage chamber;
a plurality of supply valves for opening/closing the supply passages respectively;
a return valve for opening/closing the return passage;
an electromagnetic actuating means for actuating the supply valves and the return valve on the basis of a control signal from a controller; and
an electromagnet for generating a first power of magnetism for opening or closing one of the plurality of supply valves and a second power of magnetism for opening or closing another of the plurality of supply valves, the values of the first and second powers of magnetism are different from each other so that the plurality of supply valves open/close nonsynchronously.

9. The externally-controlled fluid coupling according to claim 8, wherein
one of the supply passages has an inner diameter different from that of another of the supply passages.

10. The externally-controlled fluid coupling according to claim 8, wherein
one of the supply passages includes a plurality of exits to the operation chamber.

11. The externally-controlled fluid coupling according to claim 8, wherein
each of the supply valves includes a spring for exerting biasing force to close the supply valve, the return valve includes a spring for exerting biasing force to close the return valve, each of the supply valves and the return valve is opened in a situation where magnetic force exerted by the electromagnetic actuating means is larger than the biasing force and the biasing force is differently set between one of the springs of the supply valves and the return valve and another of the springs of the supply valves and the return valve.

12. The externally-controlled fluid coupling according to claim 8, wherein
each of the supply valves includes a spring for exerting biasing force to close the supply valve, the return valve includes a spring for exerting biasing force to close the return valve, each of the supply valves and the return valve is opened in a situation where magnetic force exerted by the electromagnetic actuating means is larger than the biasing force and an area of one of the supply valves and the return valve, the area at which magnetic force is exerted by the electromagnetic actuating means, is set to be different from an area of another of the supply valves and the return valve, the area at which magnetic force is exerted by the electromagnetic actuating means.
